(19) United States
(12) Patent Application Publication
(10) Pub. No.: US 2015/0289125 A1
(43) Pub. Date: Oct. 8, 2015

(54) Discovery of Proximity Services in Cellular System

(71) Applicant: NOKIA SOLUTIONS AND NETWORKS OY, Espoo (FI)

(72) Inventors: Vinh Van Phan, Oulu (FI); Ling Yu, Espoo (FI); Kari Veikko Horneman, Oulu (FI)

(21) Appl. No.: 14/439,700

(22) PCT Filed: Oct. 31, 2012
(86) PCT No.: PCT/EP2012/071582

§ 371 Date: Apr. 30, 2015

(51) Int. Cl. H04W 8/00; H04W 48/16; H04W 76/02

(52) U.S. Cl. CPC H04W 8/005; H04W 76/023; H04W 48/16

(57) ABSTRACT

This document discloses a solution for employing proximity discovery devices to carry out discovery of terminal devices registered to proximity services. The proximity discovery device is provided with an identifier that is unique for the discovery procedure, and the proximity discovery device transmits its unique identifier in a discovery signal. Terminal devices registered to the proximity services and detecting the discovery signal indicate their presence to the proximity discovery devices. The proximity discovery device then creates a discovery reports on the basis of the contact(s) from the terminal device(s) and transmits the discovery report to a network element of a cellular communication system managing the proximity services.

### FIELD

The invention relates to the field of wireless communications and, particularly, to discovering a device discovery in connection with proximity services in a cellular communication system.

### BACKGROUND

Proximity services may be defined as short-range communication services provided by a cellular communication system. The proximity services may comprise direct device-to-device (D2D) connections between terminal devices, wherein data is transferred directly from one terminal device to another without routing it through a base station of the cellular communication system. The base station may control parameters of the D2D connection, e.g. radio resource management. Another example of the proximity services is establishment of ad hoc local area cells within a macro cell of the cellular communication system. A coverage area of the local area cell may be considerably smaller than a coverage area of the macro cell, and the local area cell may be established to improve coverage of the macro cell and/or to server a determined group of terminal devices, for example. A discovery procedure may be used to detect the devices supporting the proximity services and to configure the proximity services accordingly.

### BRIEF DESCRIPTION

The present invention is defined by the independent claims.

Embodiments of the invention are defined in the dependent claims.

### LIST OF DRAWINGS

Embodiments of the present invention are described below, by way of example only, with reference to the accompanying drawings, in which

FIG. 1 illustrates communication scenario to which embodiments of the invention may be applied;

FIGS. 2 to 4 illustrate a discovery procedure in a proximity discovery device, terminal device, and a network element according to some embodiments of the invention;

FIG. 5 illustrates a signalling diagram of the discovery procedure in a system according to an embodiment of the invention;

FIG. 6 illustrates a procedure for creating a discovery report in a proximity discovery device according to an embodiment of the invention;

FIG. 7 illustrates a signalling diagram of a procedure for enabling a terminal device to detect appropriate proximity discovery devices;

FIG. 8 illustrates a procedure for configuring proximity services in a network element controlling proximity services of multiple cellular communication systems according to an embodiment of the invention;

FIG. 9 illustrates managing identifiers during the discovery procedure according to an embodiment of the invention; and

FIGS. 10 to 12 illustrate block diagrams of apparatuses according to some embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

FIG. 1 illustrates a wireless communication scenario to which embodiments of the invention may be applied. Referring to FIG. 1, a macro cell base station 104 belonging to a radio access network of a cellular communication system provides terminal devices 110, 112, 114 with wireless cellular connectivity within its coverage area 100 comprising one or more cells. The base station 104 may communicate with the terminal devices according to any one of the following cellular communication protocols: Global System for Mobile Communications (GSM), Universal Mobile Telecommunication System (UMTS), UMTS Long-Term Evolution (LTE), UMTS LTE-Advanced (LTE-A), Worldwide Interoperability for Microwave Access (WiMAX). The base station 104 may connect to a core network 130 of the cellular communication system, wherein the core network is called Evolved Packet Core (EPC) in connection with LTE systems. The core network 130 may comprise a mobility management entity (MME) 132 controlling mobility, e.g. tracking terminal devices, bearer (de)activation, authentication, and cellular identifier allocation.

The cellular communication system and the terminal devices may support the proximity services described above in the Background and/or defined in specifications published within the 3^{rd} Generation Partnership Project. A proximity services registration and control (PSRC) server 134 may control and configure the proximity services on a higher level, e.g. on an application layer. The PSRC server 134 may configured a terminal device or an access point to establish a local area cell within the coverage area of the cellular communication system, and/or it may configure terminal devices to establish direct device-to-device (D2D) connections. Yet another example of proximity services is a proximity discovery where it is determined whether or not two terminal devices are sufficiently close to each other. A user of one terminal device may be provided with information on whether another user is located in the same neighbourhood or, in general, on the location of the other user. Whenever the proximity services necessitate network control, the PSRC server 134 may configure the corresponding network elements of the cellular communication system to carry out associated control functions, e.g. the MME 132 and/or the base station 104. The terminal devices 110 to 114 supporting the proximity services may register to the proximity services by carrying out a registration procedure with the PSRC server 134. As a consequence, the PSRC server 134 is aware of the terminal devices capable of employing the D2D connections, serving as local area cells, or employing other proximity services. In an embodiment, the PSRC server 134 makes a proximity association between at least two terminal devices to store a record of a possibility for establishing at least on proximity service between the at least two terminal devices. Accordingly, the proximity service may be triggered rapidly without first checking whether or not it is possible to create the proximity service, e.g. the D2D connection, between the terminal devices.

With respect to a discovery procedure in which the number of terminal devices registered to the proximity services and their approximate location are determined, embodiments of the invention employ proximity discovery devices 120, 122 disposed within the coverage area of the cellular communication system, e.g. within the coverage area 100 of the base station 104. In some instances, the proximity discovery devices 120, 122 may be called proximity discovery agents (PDA). The proximity discovery devices 120, 122 may be terminal devices dedicated to carry out the proximity discovery, or they may be access points capable of communication with the cellular communication system and with the PSRC server 134, e.g. IEEE 802.11 access points.

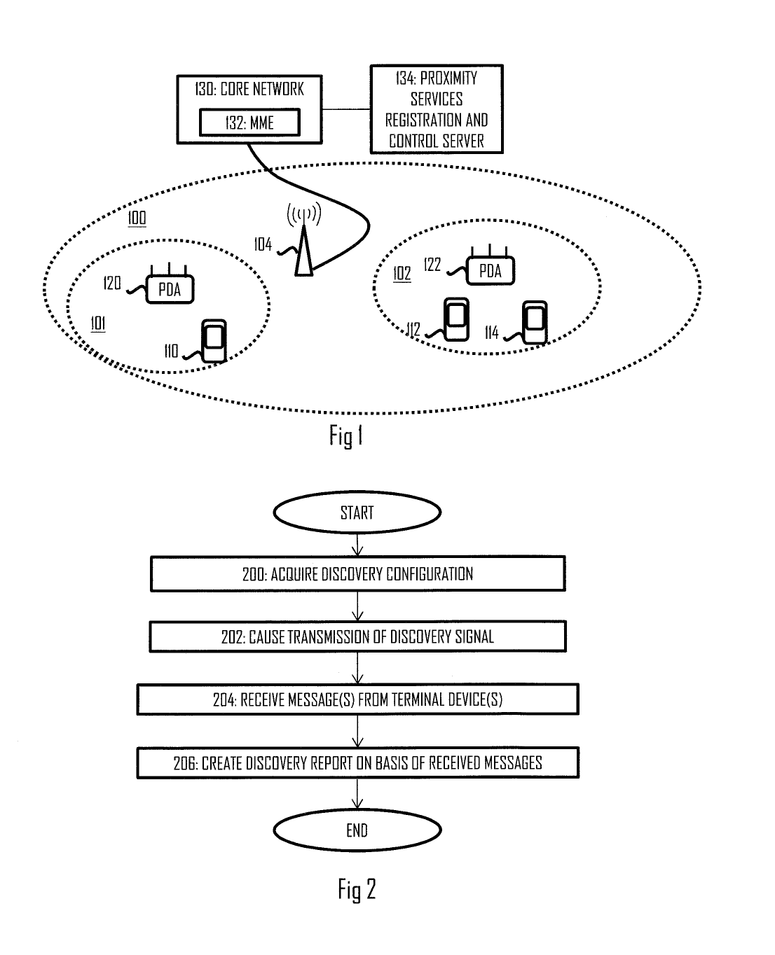

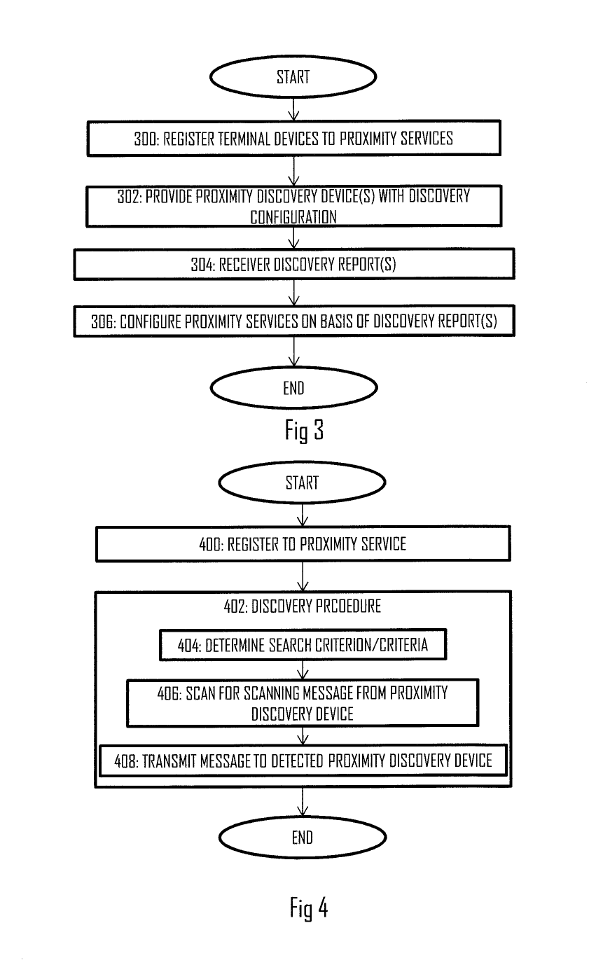

Let us now consider the discovery procedure from the viewpoint of the proximity discovery device 120, 122 (FIG. 2), the PSRC server 134 (FIG. 3), and the terminal device 110 to 114 (FIG. 4) according to embodiments of the invention. The proximity discovery procedure employs proximity discovery devices 120, 122 that broadcast discovery signals, receive communication messages from terminal devices 110 to 114 in response to the discovery signals detected by the terminal devices, and report to the PSRC server 134 discovery reports on the basis of the received communication messages.

Referring to FIG. 2, let us describe a method for carrying out the discovery procedure in the proximity discovery device 120, 122 connected to the cellular communication system. The proximity discovery device 120, 122 acquires discovery configuration from a network element in block 200. The discovery configuration may dedicate the proximity discovery device 120, 122 to discover and report to the network element terminal devices registered to a proximity service and located in a coverage area of the proximity discovery device 120, 122. Referring to FIG. 1, the coverage area 101 of the proximity discovery device 120 covers a location of a terminal device 110, while the coverage area 102 of the proximity discovery device 122 covers locations of terminal devices 112, 114. The coverage areas 101, 102 of the proximity discovery devices may be considerably smaller than the coverage area 100 of the base station 104 of the cellular communication system. Thus, the proximity discovery devices may be used to detect the possibility for the proximity services. After acquiring the discovery configuration, the proximity discovery device transmits a discovery signal in block 202. The discovery signal may be a beacon signal or another advertisement signal that indicates the presence of the proximity discovery device. In block 204, the proximity discovery device receives at least one message from at least one terminal device of the cellular communication system in response to the discovery signal. On the basis of the at least one message received from the at least one terminal device, the proximity discovery device creates a discovery report and transmits the discovery report to the network element, e.g. the PSRC server 134. The proximity discovery device may transmit the discovery signals periodically for a determined time interval.

Depending on the connection between the proximity discovery device 120, 122 and the cellular communication system, the discovery report may be transmitted in different ways. For example, if the proximity discovery device employs a direct wired connection to the PSRC server 134, e.g. an internet protocol (IP) connection, the discovery report may be transmitted directly to the PSRC server 134 over the wired connection. If the proximity discovery device employs a wired connection to the radio access network and/or core network of the cellular communication system, e.g. S1 and/or X2 interface of the UMTS LTE, the proximity discovery device may transmit the discovery report first to a base station (X2) and/or MME (S1) of the cellular communication system and, then, the discover report or at least part of it is forwarded to the PSRC server 134. If the proximity discovery device employs only a wireless connection to the radio access network, the discovery report may be transmitted to the PSRC server over a wireless interface.

Referring to FIG. 3, let us now consider the discovery procedure from the viewpoint of the network element, e.g. the PSRC server 134, the MME 132, or the base station 104, depending on how the control of the proximity service is distributed between these network elements. In block 300, terminal devices are registered to proximity services. From the viewpoint of the PSRC server 134, the registration may comprise storing a record that the terminal devices may be configured to use the proximity services. From the viewpoint of the PSRC server 134, the registration may comprise storing a record that the terminal devices may be configured with appropriate parameters to operate the proximity services, e.g. appropriate identifiers, if the proximity services are initialized by the PSRC server 134. From the viewpoint of the base station 104, the registration may comprise storing a record that radio resources may be allocated to the terminal devices for the proximity services, if the proximity services are initialized by the PSRC server 134. It may be understood that the base station 104 handles the configuration of the proximity services up to radio resource control (RRC) layer, the MME 132 handles the identifier allocation and other related functions, and the PSRC server 134 handles higher layer (application level) configuration of the proximity services, e.g. initiation and termination of the proximity services.

In block 302, the network element provides at least one proximity discovery device with the discovery configuration. As described above with reference to FIG. 2, the discovery configuration dedicates the proximity discovery device to transmit a discovery signal according to the provided discovery configuration and to discover and report terminal devices registered to the proximity service and located in a coverage area of the proximity discovery device. In block 304, the network element receives from the at least one proximity discovery device a discovery report comprising at least a subset of terminal devices that have been registered to a proximity service. In block 306, the network element configures at least one proximity service on the basis of the received discovery report(s).

Referring to FIG. 4, let us now consider the discovery procedure from the viewpoint of the terminal device. In block 400, the terminal device registers to a proximity service in the cellular communication system. This may be carried out by communicating with the PSRC server 134. In block 402, the terminal device determines to start the discovery procedure. The discovery procedure may comprise determining (block 404) at least one search criterion to distinguish a proximity discovery device from other devices performing discovery-related functions, wherein the proximity discovery device is dedicated by the cellular communication system to discover and report terminal devices registered to the proximity service and located in a coverage area of the proximity discovery device. The search criteria may comprise rules for determining identifiers of the proximity discovery devices. The search criteria may comprise determining, on the basis of signalling information received from the serving base station, for example, whether or not the proximity discovery devices are supported in the cell. The proximity discovery devices may use identifiers that are dedicated exclusively to the discovery procedure. Below, some embodiments for detecting the proximity discovery devices are described. The search criteria may be part of a proximity discovery configuration of the terminal device. The proximity discovery configuration of the terminal device may specify when to carry out the search, e.g. periodically, upon a determined event, mobility from a proximity service registration area to another (e.g. handover between two PSRC servers). Upon registering to the PSRC server or handing over from one PSRC server to another, the terminal device may carry out the scanning. The discovery configuration may be cell-specific, e.g. each base station may provide at least some of the parameters of the discovery configuration.

Upon determining the search criteria, the terminal device may start to scan for the proximity discovery devices meeting the criteria. In block 406, the terminal device scans, during the discovery procedure, for a scanning message transmitted by a proximity discovery device complying with the search criterion. Upon detecting the scanning message complying with the search criteria, the terminal device transmits (block 408) a message to the proximity discovery device so as to indicate the presence of the terminal device to the proximity discovery device. This enables the proximity discovery device to report the presence of the terminal device and its capability for the proximity services to the network element.

As described above, the discovery procedure in these embodiments employ dedicated proximity discovery devices that broadcast the discovery signal, receive contact messages from terminal devices that detected the discovery signal, and report those terminal devices to the network element(s) in the discovery report. This centralized reporting results in less signalling compared with situation where the terminal devices each report the detected proximity discovery devices.

In an embodiment, the proximity discovery devices 120, 122 transmit the discovery signal on a frequency band of the cellular communication system, and the discovery signal may comply with specifications of the cellular communication system. In another embodiment, the proximity discovery devices 120, 122 transmit the discovery signal on a frequency band outside the frequency bands of the cellular communication system, and the discovery signal may comply with specifications of a system other than the cellular communication system. For example, the proximity discovery devices may support IEEE 802.11 (Wi-Fi) specifications, and the discovery signals transmitted by the proximity discovery devices may comprise at least one of a beacon signal or a measurement pilot signal of the Wi-Fi. In this latter embodiment, the proximity discovery devices 120, 122 may transmit the discovery reports on the frequency band of the cellular communication system, provided that the discovery reports are transmitted over the wireless interface.

In an embodiment, the message transmitted by the terminal device to the proximity discovery device in response to the detection of the discovery signal comprises at least one of the following messages: a scanning request message such as a probe request, an authentication request message, or an association request message. These messages may comply with the Wi-Fi specifications or with other specifications, e.g. Bluetooth or a cellular communication system. The proximity discovery device may respond to the scanning request message with the appropriate response or omit the response upon determining that the scanning request message was received within a determined time interval after the transmission of the discovery signal related to the proximity discovery for the cellular communication system.

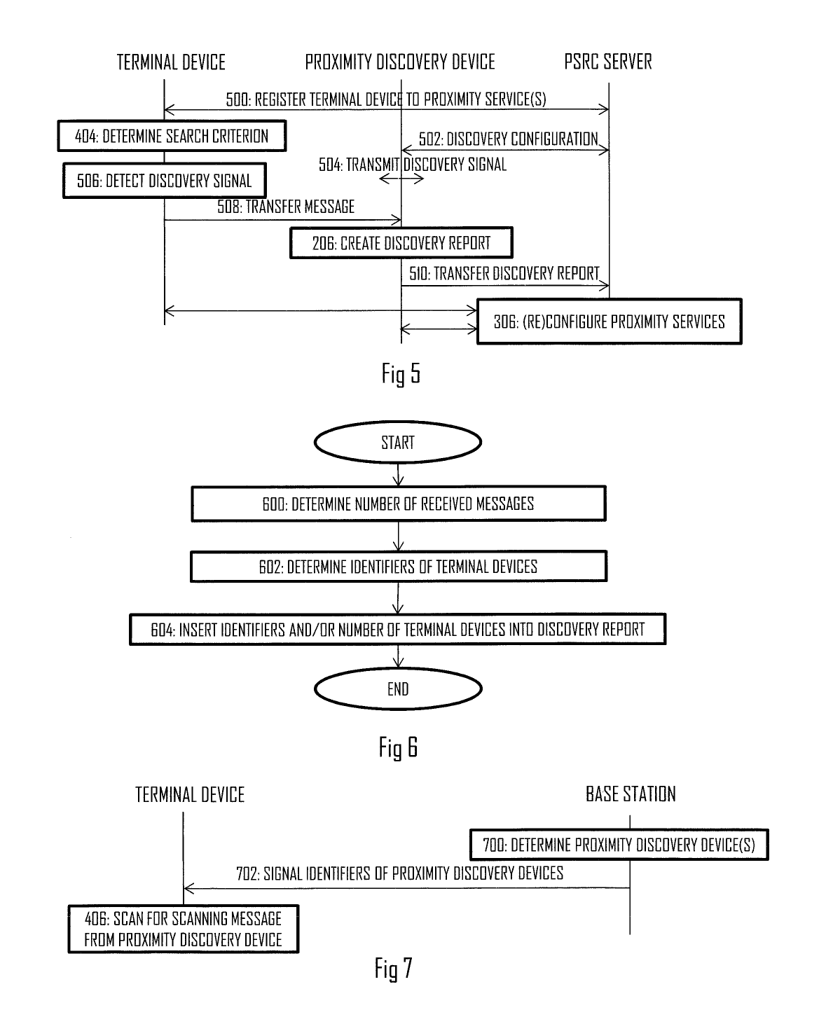

FIG. 5 combines the device-level description of FIGS. 2 to 4 into a system level description in the form of a signalling diagram showing signalling between the terminal device 110 to 114, the proximity discovery device 120, 122, and the network element 104, 132, 134 (the PSRC server 134 in this example). Referring to FIG. 5, the terminal device is registered to the proximity services in 500. This may comprise signalling between the terminal device and the PSRC server. In an embodiment, the PSRC server stores one or more identifiers of the terminal device in order to identify the terminal device in the discovery reports provided by the proximity discovery devices and to configure the proximity services for the terminal device. In 502, the PSRC server determines a device to operate as the proximity discovery device and provides the device with a discovery configuration that configures the device to operate as the proximity discovery device. Before 502, the device may have operated simply as a terminal device or an access point, for example. After the configuration, the device starts the proximity discovery procedure in which is transmits the discovery signals (504) for the proximity discovery purposes. The discovery signal may comprise a specific information element indicating that it is the discovery signal for the proximity services and not a conventional discovery signal of a Wi-Fi network, for example. This enables the proximity discovery device to separate the terminal devices having registered to the proximity services from other terminal devices. Steps 502 and 504 may be carried out before or after step 500.

After registering to the proximity services, the terminal device also applies the discovery procedure. It comprises block 404 in which the terminal device determines the search criterion/criteria. Block 404 may comprise determining discovery parameters, e.g. how to identify the proximity discovery devices, how to prioritize the proximity discovery devices and/or timing of the scanning and contacting the proximity discovery devices. In an embodiment, at least some of the discovery parameters or even all of them are provided by the network element. In another embodiment, at least some of the discovery parameters or even all of them are determined autonomously by the terminal device.

The timing may be determined by the terminal device autonomously or it may be configured by a network element, e.g. the base station 104 or the PSRC server 134. In block 506, the terminal device detects the discovery signal transmitted by the proximity discovery device. In response to the detection of the discovery signal and determining that the discovery signal is transmitted by a proximity discovery device, the terminal device transmits the message to the proximity discovery device in 508. Upon receiving the message in 508 and other messages from other terminal devices within a determined time interval after the transmission of the discovery signal in 504, the proximity discovery device creates the discover report (206) and transmits the discovery report to the PSRC server (510). On the basis of the discovery report received from the proximity discovery device in 510 and from other proximity discovery devices, the PSRC server configures or reconfigures the proximity services in 306. Block 306 may comprise configuring the terminal device to start, terminate, or change the configuration of a D2D connection, configuring the proximity discovery device to establish or terminate operation as a local area cell in the cellular communication system, etc.

In an embodiment, the proximity discovery device is a terminal device of the cellular communication system. The network element(s) of the cellular communication system may select the terminal device(s) to operate as the proximity discovery devices on the basis of at least some of the following criteria: the terminal device is in a connected state with respect to the cellular communication system, a channel state between the terminal device and a serving base station of the cellular communication system is sufficiently high (e.g. above a determined channel state threshold), current battery capacity of the terminal device is sufficiently high (e.g. above a determined battery status threshold), the terminal device is located within a determined geographical location not yet covered by any proximity discovery device, and/or the terminal device supports multi-radio operation such as using another radio access protocol for the discovery procedure (e.g. Wi-Fi).

With respect to the timing of the scanning in the terminal device, the terminal device may periodically scan for the discovery signals. In another embodiment, the scanning and the transmission of the discovery signals are controlled by the network element, e.g. by the PSRC server or the base station 104. The network element may choose to initiate so-called massive discovery in which multiple proximity discovery devices transmit the discovery signals and multiple terminal devices start the scanning substantially at the same time. The massive discovery provides for a synchronized discovery procedure between the terminal device, between the proximity discovery devices, and between the terminal devices and the proximity discovery devices. The massive discovery may be triggered on a need basis, periodically, and/or in upon occurrence of an event triggering the massive discovery. With respect to the massive discovery, the network element may transmit to the proximity discovery devices a triggering message identifying the proximity discovery devices that are selected to participate in the massive discovery. The identification may be based on adding the identifiers of the selected proximity discovery devices in the triggering message. Upon discovering its identifier in the triggering message, a terminal device may assume a role of the proximity discovery device temporarily for the duration of the massive discovery, e.g. from the reception of the triggering message to the transfer of the discovery report. The proximity discovery devices may send the discovery report once per massive discovery procedure, multiple times during the massive discovery procedure, or at the end of the massive discovery procedure.

In an embodiment, at least some of the terminal devices are employed as secondary proximity discovery devices during the massive discovery. The terminal device may be selected as the proximity discovery device on the basis of the above-described selection criteria. The terminal device may be configured to operate as the secondary proximity discovery device by the network element(s) at the moment of starting the massive discovery in which case the network element(s) may provide the terminal device with the proximity discovery configuration at the beginning of the massive discovery. In another embodiment, the terminal device is provided with the proximity discovery configuration beforehand, and the terminal device assumes the role of the proximity discovery device only when the massive discovery is started. The network element(s) may provide signalling information that enables the terminal device to distinguish the concurrent massive discovery of the devices in the same cell or area from a discovery procedure of an individual proximity discovery device or a terminal device. In the latter embodiment, the terminal device may make an autonomous decision of whether or not its current operational parameters meet the criteria for the operation as the proximity discovery device. If they do, the terminal device may make the decision to assume the role of the proximity discovery device for the duration of the massive discovery. The terminal device may also apply a randomizing functionality such that the terminal device may assume the role of the proximity discovery device with a certain probability (less than 100%), provided that it meets the criteria.

Let us now describe an embodiment of block 206 (the creation of the discovery report in the proximity discovery device) in greater detail with reference to FIG. 6. Upon transmitting the discovery signal(s) and receiving the messages from the terminal devices, the proximity discovery device determines the number of terminal devices from which the messages were received (block 600). The messages may comprise an identifier of the transmitting terminal device, and the identifiers of the terminal devices may be determined in block 602. The proximity discovery device may carry out block 600, 602, or both of them. In block 604, the proximity discovery device inserts the identifiers of the terminal devices determined in block 602 and/or the number of terminal devices determined in block 600 into the discovery report and transmits the discovery report to the network element. The network element may use the identifiers of the terminal devices in the establishment of D2D connection, for example, such that a D2D connection may be established between two terminal devices reported by the same proximity discovery device. The network element may use the number of detected terminal devices in determining whether or not to configure the reporting proximity discovery device or another device close to the reporting proximity discovery device to establish or terminate a local area cell. For example, if the number of terminal devices exceeds a determined threshold representing a minimum number of terminal devices to make the local area cell effective, the network element may determine to establish the local area cell or to maintain the operation of the local area cell. On the other hand, if the number of terminal devices is below the threshold, the network element may determine not to establish the local area cell or to terminate the operation of an active local area cell. A local area cell may be defined as a sub-cell having a coverage area that is within the coverage area of a macro cell of a macro cell base station 104. A transmission range of a local area base station may be in the order of dozens of meters so it may be completely encircled by the coverage area of the macro cell.

Let us now consider some embodiments for enabling the terminal device to quickly and efficiently distinguish the proximity discovery devices from other devices of the cellular communication system and/or the other network used as a service extension for the cellular communication system, e.g. the Wi-Fi network. FIG. 7 illustrates a signalling diagram between the terminal device and the network element (the base station 104 in this example). As described above, the PSRC server 134 may select the proximity discovery devices, and the MME 132 may assign identifiers to the proximity discovery devices. The PSRC server 134 and/or the MME 132 may then signal to the base station 104 the proximity discovery devices currently active in the coverage area 100 of the base station 104 and their identifiers. The proximity discovery devices may employ different identifiers for the operation as the proximity discovery device and as its primary role, e.g. the access point or the terminal device. The base station 104 may then determine the proximity discovery devices currently active in its coverage area and their identifiers in block 700. Then, the base station 104 may signal the identifier(s) of the determined proximity discovery device(s) active within its coverage area to the terminal device in 702. The signalling may be carried out as inserting the identifiers of the proximity discovery devices into system information transmitted by the base station 104 as broadcast signalling or as dedicated signalling. Upon determining the identifiers of the proximity discovery devices on the basis of the received signalling information, the terminal device may focus the scanning in block 406 to discovery signals comprising an identifier of (any) one of the proximity discovery devices.

In another embodiment, the terminal device may determine the identifiers of the proximity discovery devices implicitly without using explicit identifiers provided by the cellular communication system. The use of implicit determination may be preconfigured by the network element, e.g. the base station or the MME, and the network element may also provide rules for making the determination. In this embodiment, the MME 132 may assign to the proximity discovery devices identifiers that have a common part and a unique part. The common part is common and exclusive to all proximity discovery devices and enables the categorization of the device as the proximity discovery device. The common part may be a determine number of first or last bits of the identifier, for example. The terminal device may then search for the common part in the identifier comprised in the received discovery signal and determine on the basis of the value of the common part whether or not the transmitter of the discovery signal is the proximity discovery device. In another embodiment, the MME 132 assigns to the proximity discovery devices identifiers that have a part that is common with a corresponding part of an identifier of the base station 104 in whose coverage area the proximity discovery devices reside. Accordingly, the base station 104 and the proximity discovery devices within the coverage area 100 of the base station 104 have an identical common part in their identifiers, and the terminal device may use this common part when determining the search criteria in block 404. The search may be focused on the discovery signals comprising an identifier having the same common part with the identifier of the serving base station 104.

In another embodiment related to determining the search criteria in block 404, the terminal device may filter the proximity discovery devices from which the discovery signal has been detected. The filtering may comprise determining a subset of proximity discovery device to which to transmit the message. The filtering may be based on selecting a predetermined number of proximity discovery devices to which to transmit the message, selecting the proximity discovery devices on the basis of their primary modes (terminal device, access point), etc. Then, the terminal device may transmit the message to the determined proximity discovery devices from which the discovery signal was detected and omit transmission of the message to the rest of the proximity discovery devices from which the discovery signal was detected.

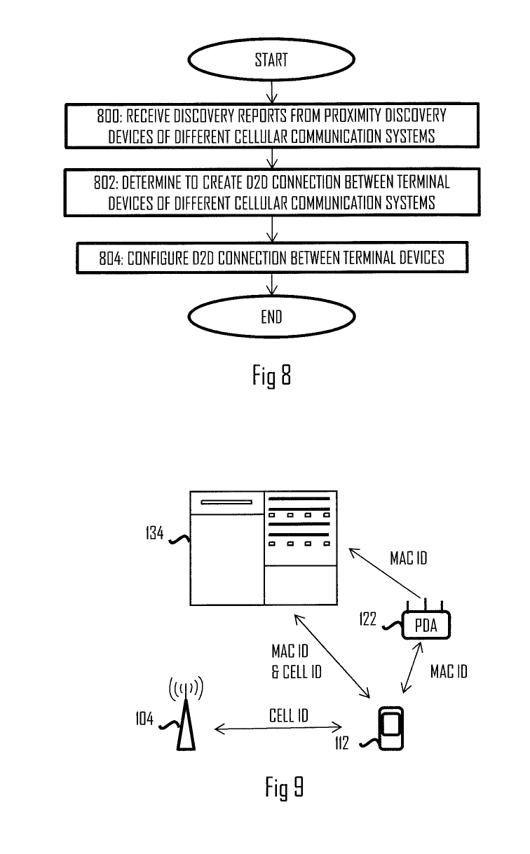

The PSRC server 134 may be comprised in a cellular communication system, e.g. in its core network, or it may be connected to the cellular communication system. In an embodiment, the PSRC server 134 is connected to multiple cellular communication systems and it controls the proximity services in the multiple cellular communication systems. The PSRC server 134 may operate as a common PSRC server, and it may configure proximity services between devices of the same cellular communication system and between devices of different cellular communication systems. For example, the PSRC server 134 may configure two terminal devices having different network operators to establish a D2D connection between the terminal devices or provide a terminal device with information on the location of another terminal device and/or distance to the other terminal device. As known in the art, coverage areas of the cellular communication systems of different operators overlap, and the PSRC server 134 may control the proximity services of multiple operators within a control area of the PSRC server 134. FIG. 8 is a flow diagram illustrating the discovery procedure in the PSRC server 134 connected to multiple cellular communication systems of different operators. Referring to FIG. 8, the PSRC server 134 may configure proximity discovery devices in the multiple cellular communication systems and receive the discovery reports from the proximity discovery devices (block 800). Then, the PSRC server may configure the proximity services in the different cellular communication systems and between the cellular communication systems on the basis of the received discovery reports. In this embodiment, the PSRC server 134 determines to create a D2D connection between terminal devices of different network operators (block 802). Block 802 may be carried out on the basis of receiving a discovery report from one or more proximity discovery devices of the different cellular communication systems, wherein the discovery reports indicate that the two terminal devices are within close proximity with respect to each other. The PSRC server 134 may store locations of the proximity discovery devices and their respective coverage areas, so the PSRC server 134 may determine, on the basis of the identities of the reporting proximity discovery devices and the contents of the discovery reports, whether or not two terminal devices are within such proximity from each other that the D2D connection is possible. The initiation of the D2D connection establishment may be determined on the application layer, e.g. on the basis of a D2D connection establishment request received from one of the terminal devices. In block 804, the PSRC server launches the D2D connection establishment and configures the parameters of the D2D connection. Block 804 may comprise configuring MMES and serving base stations of the respective cellular communication systems to configure the parameters of the D2D connection according to state-of-the-art techniques.

In an embodiment, a proximity discovery device may carry out the discovery procedure for a plurality of cellular communication systems. This may be carried out by providing the proximity discovery device with multiple discovery configurations. The discovery configurations may be provided by the same PSRC server 134 or by different PSRC servers. Each discovery configuration may comprise a different identifier allocation, one for each discovery configuration. Accordingly, terminal devices of different cellular communication systems may scan for an identifier associated with its own cellular communication system among multiple different discovery signals transmitted by the proximity discovery device and determine to respond only to a discovery signal comprising the correct identifier. The different discovery configurations employed by the proximity discovery device may additionally comprise other parameters that differ in the different discovery configurations. For example, the proximity discovery device may employ different discovery signals, different transmission powers etc. in different discovery configurations. The proximity discovery device may employ the different discovery configurations in parallel, e.g. it may execute simultaneously multiple discovery procedures having different discovery configurations. For example, it may transmit simultaneously, e.g. alternately, discovery signals of different discovery configurations.

Let us now describe some embodiments for utilizing identifiers in the discovery procedure with reference to FIG. 9. FIG. 9 illustrates the connections between the terminal device 112 and the PSRC server 134, the base station 104, and the proximity discovery device 122 and how different identifiers are used in the different connections. For example, the terminal device is identified in the cellular communication system and in the base station 104 by using a cellular identifier, e.g. a cellular radio network temporary identifier (C-RNTI). The terminal device may also register to the proximity services with the cellular identifier, e.g. the PSRC server 134 may identify the terminal device in the proximity services by using the cellular identifier. The PSRC server 134 may use the cellular identifier when configuring the proximity services, e.g. when configuring the terminal device to use the proximity services. The cellular identifier of the terminal device may be inserted into any proximity service configuration message transferred between the PSRC server 134 and the terminal device 112. In an embodiment, the terminal device provides the PSRC server 134 with at least one other identifier of the terminal device 112 when registering to the proximity service. The at least one other identifier may be used to identify the terminal device to the proximity discovery devices that carry out the discovery procedure by using a different communication protocol than the communication protocol of the cellular communication system. The at least one other identifier may comprise a medium access control (MAC) address, a hardware address, or a physical layer address of the terminal device. This identifier may be assigned by a manufacturer of a network interface card of the terminal device, e.g. a Wi-Fi modem. The at least one other identifier may be a non-cellular identifier of the terminal device. In another embodiment, the other identifier may be an application layer identifier such as a cellular number (a mobile phone number) of the terminal device or a nickname of the terminal device registered to the proximity services. In general, the other identifier may be any identifier that is different from the cellular identifier (C-RNTI) of the terminal device. The other identifier is called a discovery identifier because of its use in the discovery procedure, but it may have other uses as well. The PSRC server 134 may then store the mapping between the at least one other identifier and the cellular identifier in a proximity service database. The mapping may be one-to-one meaning that the PSRCF server 134 may determine the cellular identifier of the terminal device upon receiving the at least one other identifier.

When transmitting the message to the proximity discovery device in response to the detection of the discovery signal transmitted by the proximity discovery device, the terminal device may insert the other identifier, e.g. the MAC address, in the message. The proximity discovery device may collect the corresponding identifiers, e.g. the MAC addresses, from the different terminal devices and forward these identifiers to the PSRC server in the discovery report. The PSRC may then utilize the mapping between the identifiers comprised in the received discovery report(s) and corresponding cellular identifiers to determine the terminal devices that have been discovered by the proximity discovery device. This type of utilization of multiple identifiers may be used when the proximity discovery device operates outside the cellular frequency bands and uses a different communication protocol, e.g. the Wi-Fi.

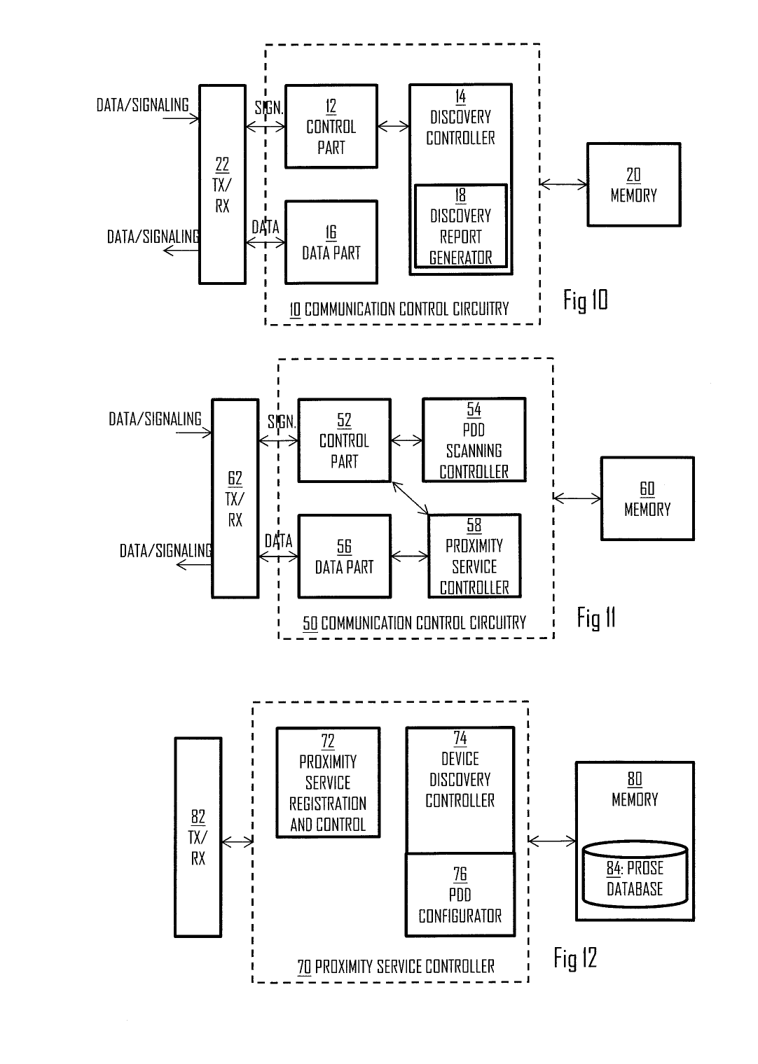

Let us now consider structural and functional components of the above-described proximity discovery device, terminal device, and network element according to embodiments of the invention with reference to FIGS. 10, 11, and 12, respectively. FIG. 10 illustrates an embodiment of an apparatus comprising means for carrying out the above-mentioned functionalities with respect to the discovery procedure in the proximity discovery device 120, 122. The apparatus may be a wireless device which complies with specifications of a cellular communication system and, additionally, specifications of another system. The wireless device may communicate with the network elements of the cellular communication system and carry out the discovery procedure by using specifications of the other system. The wireless apparatus may be or may be comprised in a computer (PC), a laptop, a tablet computer, a cellular phone, a palm computer, a base station or an access point, or any other apparatus provided with radio communication capability. It should be appreciated that in one embodiment the apparatus may carry out the functionality of the terminal device, in another embodiment the apparatus may carry out the functionality of the access point, and yet in another embodiment the apparatus may support the operation as bot the terminal device and the access point. In other embodiments, the apparatus is comprised in such a wireless device, e.g. the apparatus may comprise a circuitry, e.g. a chip, a processor, a micro controller, or a combination of such circuitries in the wireless device.

Referring to FIG. 10, the apparatus may comprise a communication controller circuitry 10 configured to control wireless communications in the wireless device. The communication controller circuitry 10 may comprise a control part 12 handling the control plane communication with respect to transmission, reception, and extraction of signalling information exchanged with the cellular communication system. The control plane may have two logical entities, one for the operation in the cellular communication system and one for the operation in the other system, e.g. the Wi-Fi. The communication controller circuitry 10 may further comprise a data part 16 that handles transmission and reception of payload data over cellular connections and/or connections established by using the other system specification. The apparatus may further comprise a discovery controller circuitry 14 configured to control the discovery procedure in the proximity discovery device. Reception of the discovery configuration from the network element(s) of the cellular communication system through the control part 12 may activate the discovery controller circuitry 14, and it may apply the parameters comprised in the discovery configuration. For example, the discovery controller circuitry 14 may configure the control part 12 to start creation of the discovery signals comprising an identifier provided in the discovery configuration. The control part 12 may then transmit the discovery signals by using the specifications of the other system, e.g. the Wi-Fi. The control part 12 may also monitor the channel between the transmissions in order to detect messages addressed to the identifier of the proximity discovery device and forward such messages to the discovery controller circuitry 14. The control part 12 may determine on the basis of the identifier comprised in the messages that the messages relate to the discovery procedure. The discovery controller circuitry 14 may comprise as a sub-circuitry a discovery report generator 18 configured to collect information related to the messages the control part 12 has received from the terminal devices, e.g. the number of such messages and/or the identifiers of the terminal devices. The discovery report generator 18 may then create the discovery report and transmit the report to the network element, e.g. the PSRC server as described above.

The circuitries 12 to 18 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 18 or all of them.

The apparatus may further comprise the memory 20 that stores computer programs (software) configuring the apparatus to perform the above-described functionalities of the proximity discovery device. The memory 20 may also store communication parameters and other information needed for the wireless communications. The apparatus may further comprise radio interface components 22 providing the apparatus with radio communication capabilities within the cellular communication system and, in some embodiments, with at least one other radio system, e.g. the Wi-Fi system. The radio interface components 22 may comprise standard well-known components such as an amplifier, filter, frequency-converter, (de)modulator, and encoder/decoder circuitries and one or more antennas. In the embodiments where the apparatus is the terminal device, the apparatus may further comprise a user interface enabling interaction with the user of the wireless device. The user interface may comprise a display, a keypad or a keyboard, a loudspeaker, etc.

In an embodiment, the apparatus carrying out the embodiments of the invention in the wireless device comprises at least one processor and at least one memory including a computer program code, wherein the at least one memory and the computer program code are configured, with the at least one processor, to cause the apparatus to carry out the functionalities of the proximity discovery device according to any one of the processes described above in connection with FIG. 2, 5, 6, or 9. Accordingly, the at least one processor, the memory, and the computer program code form processing means for carrying out embodiments of the present invention in the proximity discovery device.

FIG. 11 illustrates an embodiment of an apparatus comprising means for carrying out the above-mentioned functionalities with respect to the discovery procedure in the terminal device 110 to 114. The apparatus may be a wireless device which complies with specifications of a cellular communication system and, additionally, specifications of another system. The wireless device may operate as the terminal device of the cellular communication system and carry out the discovery procedure by using specifications of the other system. The wireless apparatus may be or may be comprised in a computer (PC), a laptop, a tablet computer, a cellular phone, a palm computer, or any other apparatus provided with radio communication capability and capable of functioning as the terminal device. It should be appreciated that in one embodiment the apparatus may carry out the functionality of the terminal device, in another embodiment the apparatus may carry out the functionality of the access point, and yet in another embodiment the apparatus may support the operation as bot the terminal device and the access point. In other embodiments, the apparatus is comprised in such a wireless device, e.g. the apparatus may comprise a circuitry, e.g. a chip, a processor, a micro controller, or a combination of such circuitries in the wireless device.

Referring to FIG. 11, the apparatus may comprise a communication controller circuitry 50 configured to control wireless communications in the wireless device. The communication controller circuitry 50 may comprise a control part 52 handling the control plane communication with respect to transmission, reception, and extraction of signalling information exchanged with the cellular communication system. The control plane 52 may have two logical entities, one for the operation in the cellular communication system and one for the operation in the other system, e.g. the Wi-Fi. The communication controller circuitry 50 may further comprise a data part 56 that handles transmission and reception of payload data over cellular connections and/or connections established by using the other system specification. The apparatus may further comprise a proximity service controller 58 configured to operate proximity services and associated connections, e.g. the D2D connections and the local area cell connections. The proximity service controller 58 may carry out the registration of the terminal device to the proximity services, as described above. The proximity service controller may transmit the identifier(s) of the terminal device in connection with the registration. The apparatus may further comprise a proximity discovery device (PDD) controller configured to carry out the scanning for the proximity discovery devices and the transmission of the messages to the proximity discovery devices, as described above. The PDD scanning controller may activate the scanning periodically, upon detecting an internal event in the terminal device, or upon receiving an external command to carry out the discovery procedure from the cellular communication system or from the PSRC server 134.

The circuitries 52 to 58 of the communication controller circuitry 50 may be carried out by the one or more physical circuitries or processors. In practice, the different circuitries may be realized by different computer program modules. Depending on the specifications and the design of the apparatus, the apparatus may comprise some of the circuitries 52 to 58 or all of them.

The apparatus may further comprise the memory 60 that stores computer programs (software) configuring the apparatus to perform the above-described functionalities of the terminal device. The memory 60 may also store communication parameters and other information needed for the wireless communications. The apparatus may further comprise radio interface components 62 providing the apparatus with radio communication capabilities within the cellular communication system and, in some embodiments, with at least one other radio system, e.g. the Wi-Fi system. The radio interface components 62 may comprise standard well-known components such as an amplifier, filter, frequency-converter, (de)modulator, and encoder/decoder circuitries and one or more antennas. In the embodiments where the apparatus is the terminal device, the apparatus may further comprise a user interface enabling interaction with the user of the wireless device. The user interface may comprise a display, a keypad or a keyboard, a loudspeaker, etc.

In an embodiment, the apparatus carrying out the embodiments of the invention in the terminal device comprises at least one processor and at least one memory including a computer program code, wherein the at least one memory and the computer program code are configured, with the at least one processor, to cause the apparatus to carry out the functionalities of the terminal device according to any one of the processes described above in connection with FIG. 3, 5, 7, or 9. Accordingly, the at least one processor, the memory, and the computer program code form processing means for carrying out embodiments of the present invention in the terminal device.

FIG. 12 illustrates an embodiment of an apparatus comprising means for carrying out the above-mentioned functionalities with respect to the discovery procedure in the network element 104, 132, 134. The apparatus may be a network element of the cellular communication system or it may be connectable to the cellular communication system to control the proximity services (ProSe) in the cellular communication system and, optionally, in other cellular communication systems. The apparatus may be or may be comprised in a computer (PC), a server computer, a base station, or any other apparatus capable of functioning as the network element. In some embodiments, the apparatus is comprised in such a network element, e.g. the apparatus may comprise a circuitry, e.g. a chip, a processor, a micro controller, or a combination of such circuitries in the network element.

Referring to FIG. 12, the apparatus may comprise a proximity service controller 50 configured to control the proximity services. The proximity service controller 70 may comprise a proximity service registration and control circuitry 72 configured to register terminal devices to the proximity services and to store information on the terminal devices that are capable of the proximity services. The proximity service registration and control circuitry 72 may in some embodiments store the mapping between the cellular identifiers of the registered terminal devices and other identifiers of the terminal devices, e.g. the MAC addresses. The apparatus may comprise a proximity service database 84 for storing the registration information and the identifier mapping. The proximity service controller 70 may further comprise a device discovery controller 74 comprising a proximity discovery device configurator 76 as a sub-circuitry. The PDD configurator 76 may select the proximity discovery devices and configure their operations by selecting parameters and providing them with the discovery configurations. The device discovery controller 74 may receive the discovery reports and extract the contents of the discovery reports, e.g. carry out the mapping between the identifiers comprised in the discovery reports and the cellular identifiers of the corresponding terminal devices being reported. The device discovery controller may further store in the proximity service database records defining associations between the proximity discovery devices and the terminal devices reported by each proximity discovery device. The proximity service registration and control circuitry 72 may then use these records in determining pairing of terminal devices for D2D connections, establishment of local area cells, etc.

The circuitries 72 to 76 of the communication controller circuitry 70 may be carried out by the one or more physical circuitries or processors. In practice, the different circuitries may be realized by different computer program modules. Depending on the specifications and the design of the apparatus, the apparatus may comprise some of the circuitries 72 to 76 or all of them.

The apparatus may further comprise the memory 80 that stores computer programs (software) configuring the apparatus to perform the above-described functionalities of the network element. The memory 80 may also store communication parameters and the proximity service database 84. The apparatus may further comprise a communication interface 82 providing the apparatus with communication capabilities with the cellular communication system(s), terminal devices, and the proximity discovery devices. The communication interface 82 may comprise components enabling establishment of necessary communication connections, e.g. internet protocol connections.

In an embodiment, the apparatus carrying out the embodiments of the invention in the network element comprises at least one processor and at least one memory including a computer program code, wherein the at least one memory and the computer program code are configured, with the at least one processor, to cause the apparatus to carry out the functionalities of the network element according to any one of the processes described above in connection with FIGS. 4, 5, and 7 to 9. Accordingly, the at least one processor, the memory, and the computer program code form processing means for carrying out embodiments of the present invention in the network element.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 9 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to cellular or mobile communication systems defined above but also to other suitable communication systems. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method for carrying out a discovery procedure in a proximity discovery device connected to a cellular communication system, the method comprising:
acquiring discovery configuration from a network element, wherein the discovery configuration dedicates the proximity discovery device to discover and report to the network element terminal devices registered to a proximity service and located in a coverage area of the proximity discovery device;
after acquiring the discovery configuration, causing transmission of a discovery signal comprising an identifier of the proximity discovery device, that is dedicated exclusively to the proximity discovery procedure;
receiving at least one message from at least one terminal device of the cellular communication system in response to the discovery signal, wherein the message comprises an identifier of the terminal device;
creating, on the basis of the at least one message received from the at least one terminal device, a discovery report and causing transmission of the discovery report to the network element.

2. The method of claim 1, further comprising:
causing the transmission of the discovery signal on a frequency band outside a frequency band of the cellular communication system; and
reporting the identifier of the at least one terminal device by using a message transmitted on a frequency band of the cellular communication system.

3. (canceled)

4. (canceled)

5. The method of claim 1, wherein the terminal device assumes the role of the proximity discovery device during a massive discovery during which all devices located within a determined area and configured to employ the discovery procedure carry out the discovery procedure.

6. The method of claim 1, wherein the proximity discovery device operates as an access point for the at least one terminal device during the discovery procedure.

7. The method of claim 5, wherein the proximity discovery device operates as the access point also outside the discovery procedure.

8. The method of claim 1, wherein the message received from the at least one terminal device in response to the discovery signal is at least one of the following: an association request, an authentication request, and a probe request.

9. The method of claim 1, wherein the report comprises at least one discovery identifier of the at least one terminal device from which the message has been received during the discovery procedure, wherein the discovery identifier is different from a cellular identifier used to identify the terminal device in the cellular communication system.

10. (canceled)

11. A method for carrying out a discovery procedure in a network element connected to at least one cellular communication system, the method comprising:
registering terminal devices to proximity services in the at least one cellular communication system;
providing at least one proximity discovery device of the at least one cellular communication system with a discovery configuration, wherein the discovery configuration assigns to the proximity discovery device an identifier that is dedicated exclusively to the proximity discovery and dedicates the proximity discovery device to transmit a discovery signal according to the provided discovery configuration and comprising said identifier, and to discover and report terminal devices registered to the proximity service and located in a coverage area of the proximity discovery device;
receiving from the at least one proximity discovery device a discovery report indicating at least a subset of terminal devices that have been registered to a proximity service; and
configuring at least one proximity service in the at least one cellular communication system on the basis of the received discovery report.

12. (canceled)

13. (canceled)

14. The method of claim 11, wherein said configuring the at least one proximity service comprises at least one of the following: selecting at least two terminal devices reported by the same proximity discovery device to establish a direct device-to-device connection between them; configuring a local area base station located within a coverage area of a macro cell base station of the cellular communication system to establish or terminate operation of a local area cell; providing at least one terminal device with location or proximity information on at least one other terminal device; and making a proximity association between at least two terminal devices to store a record of a possibility for establishing at least on proximity service between the at least two terminal devices.

15. The method of claim 11, wherein said configuring the at least one proximity service comprises configuring at least one of the proximity discovery devices to establish a local area cell within a macro cell of the cellular communication system.

16. The method of claim 11, further comprising: providing the terminal devices of the at least one cellular communication system with configuration information enabling the terminal devices to distinguish the proximity discovery devices from other devices of the at least one cellular communication system.

17. (canceled)

18. The method of claim 18, wherein each proximity discovery device is associated with a determined cellular communication system, the method further comprising using a discovery report originated from a proximity discovery device of a first cellular communication system to configure a proximity service of a second cellular communication system.

19. The method of claim 18, wherein the discovery report comprises a discovery identifier of the at least one terminal device, the method further comprising: mapping the discovery identifier of the at least one terminal device to a cellular identifier of the terminal device.

20. A method for carrying out a discovery procedure in a terminal device of a cellular communication system, the method comprising:
registering the terminal device to a proximity service in the cellular communication system;
determining to start the discovery procedure and at least one search criterion to distinguish a proximity discovery device from other devices performing discovery-related functions, wherein the proximity discovery device is dedicated by the cellular communication system to discover and report terminal devices registered to the proximity service and located in a coverage area of the proximity discovery device;
scanning, during the discovery procedure, for a scanning message transmitted by a proximity discovery device complying with the search criterion, wherein the terminal device detects the proximity discovery i o device on the basis of its identifier comprised in the scanning message and dedicated exclusively to the proximity discovery; and
upon detecting the scanning message, causing transmission of a message to the proximity discovery device so as to indicate the presence of the terminal device to the proximity discovery device, wherein the message comprises an identifier of the terminal device.

21. The method of claim 20, further comprising:
receiving a scanning message from a plurality of proximity discovery devices; and
selecting a subset of the plurality of proximity discovery devices; and
causing transmission the message only to the selected subset of the plurality of proximity discovery devices.

22. The method of claim 20, further comprising:
transmitting, in connection with registering the terminal device to the proximity service, a discovery identifier of the terminal device to a network element managing the proximity service, wherein the terminal is identified in the proximity service by using a cellular identifier of the terminal device;
transmitting the discovery identifier in the message to the proximity discovery device and using the discovery identifier to identify the terminal device to the proximity discovery device.

23. The method of claim 20, further comprising carrying out the scanning and the transmission of the message on a frequency band outside a frequency band of the cellular communication system.

24. An apparatus comprising:
at least one processor; and
at least one memory including a computer program code, wherein the at least one memory and the computer program code are configured, with the at least one processor, to cause the apparatus to:
acquire a discovery configuration originating from a network element connected to a cellular communication system, wherein the discovery configuration dedicates the apparatus to operate as a proximity discovery device and to discover and report to the network element terminal devices registered to a proximity service and located in a coverage area of the proximity discovery device;
after acquiring the discovery configuration, cause transmission of a discovery signal comprising an identifier of the proximity discovery device that is dedicated exclusively to the proximity discovery procedure;
acquire at least one message originated from at least one terminal device of the cellular communication system in response to the discovery signal, wherein the message comprises an identifier of the terminal device;
create, on the basis of the at least one message received from the at least one terminal device, a discovery report and cause transmission of the discovery report to the network element.

25. The apparatus of claim 24, wherein the at least one memory and the computer program code are configured, with the at least one processor, to cause the apparatus to:
cause the transmission of the discovery signal on a frequency band outside a frequency band of the cellular communication system; and
report the identifier of the at least one terminal device by using a message transmitted on a frequency band of the cellular communication system.

26. (canceled)

27. (canceled)

28. The apparatus of claim 24, wherein the apparatus assumes the role of the proximity discovery device during a massive discovery during which all devices located within a determined area and configured to employ the discovery procedure carry out the discovery procedure.

29. The apparatus of claim 24, wherein the apparatus is configured to operate as an access point for the at least one terminal device during the discovery procedure.

30. The apparatus of claim 29, wherein the apparatus operates as the access point also outside the discovery procedure.

31. The apparatus of claim 24, wherein the message acquired from the at least one terminal device in response to the discovery signal is at least one of the following: an association request, an authentication request, and a probe request.

32. The apparatus of claim 24, wherein the report comprises at least one discovery identifier of the at least one terminal device from which the message has been received during the discovery procedure.

33. (canceled)

34. An apparatus comprising:
at least one processor; and
at least one memory including a computer program code, wherein the at least one memory and the computer program code are configured, with the at least one processor, to cause the apparatus to:
register terminal devices to proximity services in at least one cellular communication system;
provide at least one proximity discovery device of the at least one cellular communication system with a discovery configuration, wherein the discovery configuration assigns to the proximity discovery device an identifier that is dedicated exclusively to the proximity discovery and dedicates the proximity discovery device to transmit a discovery signal according to the provided discovery configuration and comprising said identifier, and to discover and report terminal devices registered to the proximity service and located in a coverage area of the proximity discovery device;
acquire from the at least one proximity discovery device a discovery report indicating at least a subset of terminal devices that have been registered to a proximity service; and
configure at least one proximity service in the at least one cellular communication system on the basis of the received discovery report.

35. (canceled)

36. (canceled)

37. The apparatus of claim 34, wherein the at least one memory and the computer program code are configured, with the at least one processor, to cause the apparatus to configure the at least one proximity service comprises by carrying out at least one of the following: selecting at least two terminal devices reported by the same proximity discovery device to establish a direct device-to-device connection between them; configuring a local area base station located within a coverage area of a macro cell base station of the cellular communication system to establish or terminate operation of a local area cell; providing at least one terminal device with location or proximity information on at least one other terminal device; and making a proximity association between at least two terminal devices to store a record of a possibility for establishing at least on proximity service between the at least two terminal devices.

38. The apparatus of claim 34, wherein the at least one memory and the computer program code are configured, with the at least one processor, to cause the apparatus to configure the at least one proximity service by configuring at least one of the proximity discovery devices to establish a local area cell within a macro cell of the cellular communication system.

39. The apparatus of claim 34, wherein the at least one memory and the computer program code are configured, with the at least one processor, to cause the apparatus to provide the terminal devices of the at least one cellular communication system with configuration information enabling the terminal devices to distinguish the proximity discovery devices from other devices of the at least one cellular communication system.

40. (canceled)

41. The apparatus of claim 34, wherein each proximity discovery device is associated with a determined cellular communication system, and wherein the at least one memory and the computer program code are configured, with the at least one processor, to cause the apparatus to use a discovery report originated from a proximity discovery device of a first cellular communication system to configure a proximity service of a second cellular communication system.

42. The apparatus of claim 34, wherein the discovery report comprises a discovery identifier of the at least one terminal device, and wherein the at least one memory and the computer program code are configured, with the at least one processor, to cause the apparatus to map the discovery identifier of the at least one terminal device to a cellular identifier of the terminal device.

43. An apparatus comprising:
at least one processor; and
at least one memory including a computer program code, wherein the at least one memory and the computer program code are configured, with the at least one processor, to cause the apparatus to:
register to a proximity service in the cellular communication system;
determine to start the discovery procedure and at least one search criterion to distinguish a proximity discovery device from other devices performing discovery-related functions, wherein the proximity discovery device is dedicated by the cellular communication system to discover and report apparatuses registered to the proximity service and located in a coverage area of the proximity discovery device;
cause scanning, during the discovery procedure, for a scanning message transmitted by a proximity discovery device complying with the search criterion, wherein the apparatus is configured to detect the proximity discovery device on the basis of its identifier comprised in the scanning message and dedicated exclusively to the proximity discovery; and
upon detecting the scanning message, cause transmission of a message 5 to the proximity discovery device so as to indicate the presence of the apparatus to the proximity discovery device, wherein the message comprises an identifier of the apparatus.

44. The apparatus of claim 43, wherein the at least one memory and the computer program code are configured, with the at least one processor, to cause the apparatus to:
acquire a scanning message originated from a plurality of proximity discovery devices; and
select a subset of the plurality of proximity discovery devices; and
cause transmission the message only to the selected subset of the plurality of proximity discovery devices.

45. The apparatus of claim 43, wherein the at least one memory and the computer program code are configured, with the at least one processor, to cause the apparatus to:
cause, in connection with registering the apparatus to the proximity service, transmission of a discovery identifier of the apparatus to a network element managing the proximity service, wherein the apparatus is identified in the proximity service by using a cellular identifier of the apparatus;
cause transmission of the discovery identifier in the message to the proximity discovery device and use the discovery identifier to identify the terminal device to the proximity discovery device.

46. The apparatus of claim 43, wherein the at least one memory and the computer program code are configured, with the at least one processor, to cause the apparatus to carry out the scanning and the transmission of the message on a frequency band outside a frequency band of the cellular communication system.

47. (canceled)

48. (canceled)

49. (canceled)
